(19) United States
(12) Patent Application Publication
(10) Pub. No.: US 2011/0167932 A1
(43) Pub. Date: Jul. 14, 2011

(54) COARSE PARTICLE EXPOSURE MONITOR

(75) Inventors: Jonathan W. Thornburg, Durham, NC (US); Charles Rodes, Cary, NC (US); Philip Lawless, Durham, NC (US)

(73) Assignee: Research Triangle Institute, Research Triangle Park, NC (US)

(21) Appl. No.: 13/119,261

(22) PCT Filed: Jul. 10, 2009
(86) PCT No.: PCT/US09/50258

§ 371 Date: Mar. 16, 2011

Related U.S. Application Data
(60) Provisional application No. 61/097,751, filed on Sep. 17, 2008.

(51) Int. Cl. G01N 1/22

(52) U.S. Cl. 73/863.23

(57) ABSTRACT

A filter apparatus that includes a housing having at least one opening by which a fluid is Introduced thereto, a first plate inside the housing and having a plurality of inlets offset from a central axis of the housing and angularly separated from each other. The inlets are configured to pass the fluid thereto. The filter apparatus includes a second plate inside the housing and disposed downstream from the first plate. The second plate has angularly extending outlets disposed at a radial distance from the central axis which is beyond the plurality of inlets such that the fluid is diverted radially outward in passing from the first plate through the second plate. The filter apparatus includes a first filter provided on the second plate underneath the plurality of inlets and configured to trap particles in the fluid which are not diverted to the angularly extending outlets, and includes an exit.

### BACKGROUND OF THE INVENTION

1. Field of the Invention

This invention relates to a filter apparatus for filtering or sampling aerosol particles. This invention further relates, but is not limited to, a coarse portable exposure monitor (CPEM) for personal environment monitoring and relates to a system for particle detection.

2. Discussion of the Background

Inertial impactor, aerosol impactor, or impactor all refer to an aerosol sampling or collection device that separates aerosol particles from a gaseous medium by the inertial effect of the particles. Any gas, such as air, nitrogen, oxygen, argon, helium, etc., can be a suspending gaseous medium. The aerosol particles can be a solid, a liquid, or a mixture of both. The device typically uses a nozzle to accelerate and direct the gas medium toward an impaction plate by forming an accelerated gas flow. Larger particles having a larger inertia will impact the impaction plate. Smaller particles having a smaller inertia are diverted from the impaction plate by the flow rate of the gas flow.

The particle size at which particle impaction occurs is referred to as the cut-off point. The cut-off point may be varied in accord with the nozzle size of the device and gas velocity of the particles. Smaller nozzles and higher gas velocities produce a smaller cut-off point. The cut-off point is also influenced by the gas viscosity, the shape of the nozzle, and the nozzle-to-plate distance. In an ideal particle sampler, particles larger than the cut-off point are collected with 100% efficiency; and particles smaller than the cut-off point are not collected. However, the conventional devices cannot achieve this efficiency. In a typical particle sampler, impaction does not occur at a single particle size. Rather, a transition from zero to 100% particle collection occurs over a range of particle sizes. The narrower this range, the sharper the cut-off size characteristics. In a typical particle sampler, the cut-off point is defined as the particle diameter at which 50% of the particles with a common diameter are collected.

Several single-stage particle samplers may be arranged in series to form a cascade particle sampler as disclosed by Liu et al. (U.S. Pat. No. 6,431,014 B1), the entire contents of which are herewith incorporated by reference. In cascade particle samplers, the larger particles are collected first, followed by the collection of smaller particles. For instance, in a three-stage cascade particle sampler with cut-off point diameters of 10, 3, and 1 μm, the particles larger than 10 μm are removed by the first stage; particles in the 3-to-10 μm range are removed by the second stage; and, particles in the 1-to-3 μm range are removed by the third stage. A final filter collects particles smaller than 1 μm.

FIG. 1 is a schematic diagram of a three-stage cascade particle sampler 8. As shown, each of the three particle sampler stages 8A, 8B, and 8C includes one of three central nozzles 9A, 9B, and 9C and one of three particle sampler plates 10A, 10B, and 10C, respectively. The airflow AF of particle sampler stage 8A travels from the first nozzle 9A toward the first particle sampler plate 10A. Near the first particle sampler plate 10A, the airflow AF is redirected toward an outlet 11A; and then directed to the second nozzle 9B for injection into the second particle sampler stage 8B. The airflow AF is similarly directed through the second 8B and third 8C particle sampler stages. However, one disadvantage of such an particle sampler is its physical size.

### SUMMARY OF THE INVENTION

According to one aspect of the invention, an impactor apparatus is provided which includes a first plate having a central filter and a plurality of orifices arranged around the central filter. Each orifice is configured to receive an airflow including aerosols to be captured by the filter. The filter is configured to capture a part of the aerosols directed to the central filter.

According to another aspect of the invention, a method for filtering aerosols which includes forcing an airflow including aerosols through a plurality of orifices of a first plate, the first plate having a central filter with the orifices being arranged around the central filter; directing a part of the aerosols toward the central filter; and capturing that part of the aerosols on the central filter.

It is to be understood that both the foregoing general description of the invention and the following detailed description are exemplary, but are not restrictive of the invention.

### BRIEF DESCRIPTION OF THE DRAWINGS

A more complete appreciation of the invention and many of the attendant advantages thereof will be readily obtained as the same becomes better understood by reference to the following detailed description, when considered in connection with the accompanying drawings, in which like reference numerals refer to identical or corresponding parts throughout the several views.

FIG. 1 is a schematic representation of a cascade particle sampler.

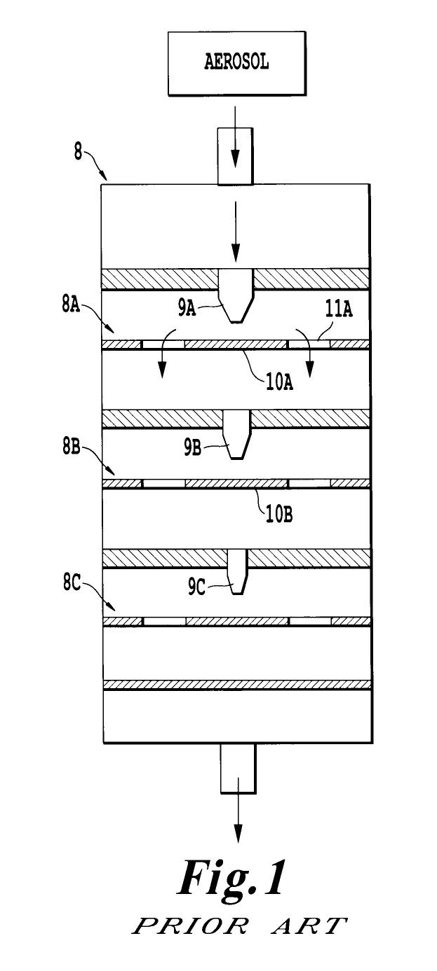

FIG. 2 is a schematic representation of an particle sampler stage according to a first non-limiting embodiment of the invention.

FIGS. 3A and 3B illustrate a focus jet plate (plan-view, cross-section view, and perspective view, respectively) according to the first non-limiting embodiment of the invention.

FIGS. 4A and 4B illustrate an impaction plate (topview and cross-section view, respectively) according to the first non-limiting embodiment of the invention.

FIGS. 5A and 5B illustrate an impaction plate (top view and cross-section view, respectively) according to a second non-limiting embodiment of the invention.

FIG. 6 illustrates a precision of the filter apparatus for fine and coarse particle filtering.

FIG. 7 illustrates the accuracy of the filter apparatus as compared to a conventional device.

FIG. 8 is a graph illustrating a relationship between the particle diameter and removal efficiency of the particles for the filter apparatus.

FIG. 9 illustrates an alternative configuration which permits coarse particles to be carried into a particle counter for capture and analysis.

### DETAILED DESCRIPTION OF THE EMBODIMENTS

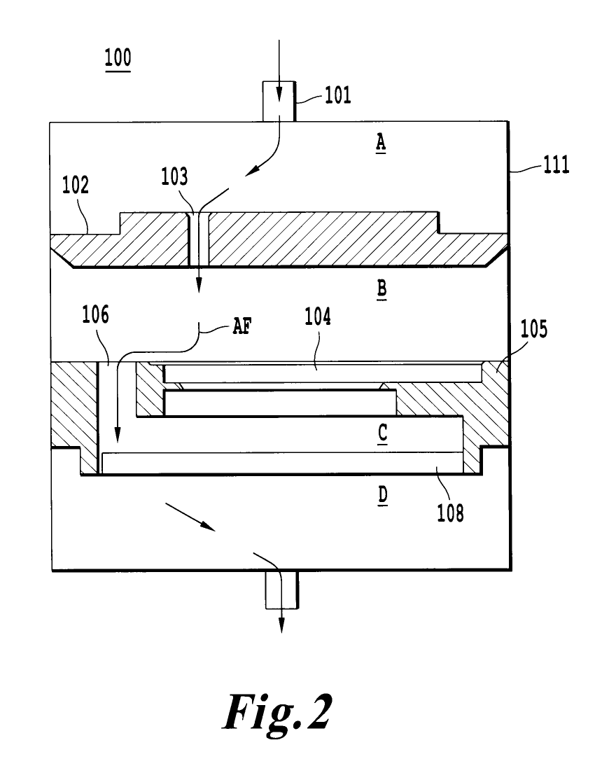

Referring now to the drawings, wherein like reference numerals designate identical or corresponding parts throughout the several views, and more particularly to FIG. 2 thereof, FIG. 2 illustrates an particle sampler in accord with a first non-limiting embodiment of the invention. The particle sampler includes four chambers A-D arranged in series and partitioned by a focus jet plate 102, an impaction plate 105, and a filter 108.

The first chamber A receives aerosols from an inlet 101 and directs the aerosols to the focus jet plate 102. The focus jet plate 102 includes a plurality of channels 103. The inlet 101 is optional, and the device according to the present embodiment may not have the inlet 101 and the walls and ceiling of the first chamber A. If the inlet 101 is present, the inlet can include a plurality of channels symmetrically situated around a centre of the ceiling of the first chamber A. Also, in this embodiment, the inlet(s) 101 are formed in the ceiling of the first chamber A to not correspond to the channels 103 formed in the floor of the first chamber A. In other words, an air flow from the inlet 101 to the channels 103 changes its direction while traveling inside the first chamber A.

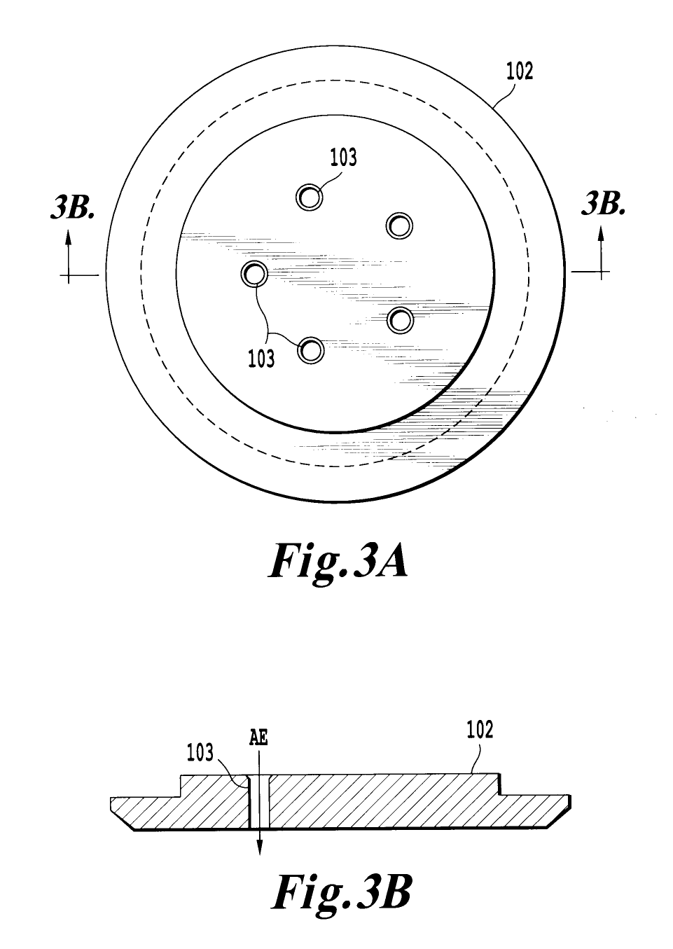

The embodiment shown in FIG. 3A employs five channels 103, but fewer or more channels may be employed. More channels distribute the particles across a wider area of the collection surface (104). Conversely, fewer channels focus the particles across a smaller area. The focus jet plate 102 can be made of any metal, as for example Aluminum (Al). The focus jet plate 102 is shown in more detail in FIGS. 3A-B. It is noted that a portion of the focus jet plate 102 can be configured to retain an aerosol capture material such as, for example, porous steel or glass fiber, [which form an aerosol capture layer 111. The aerosol capture layer 111 provided on the focus jet plate 102 may be oiled to provide better adherence to the impacting aerosols.

The diameter of the channels 103 is in the range of 0.094 to 0.20 cm However, the diameter of the channels 103 might be correlated to the diameters of the particles in the aerosols that are desired to be stored or sampled, based for example on the Stokes number defined as St=(ut)/D, where u is the speed of the particles, t is the relaxation time, and D is the diameter of the nozzle through which the particles flow, as described in Liu et al. The diameter of the holes in the nozzles 103 are selected based on the range of particles to be sorted in the second stage of the device. For the desired application of coarse particle collection, u is 589 cm/s and D is 0.12 cm to collect particles between 2.5 and 10 micrometers. For example, for collecting particles having a diameter less than 10 μm but greater than 2.5 micrometers, the preferred diameter of the channels 103 is 0.12 cm.

The channels 103 focus the aerosols from chamber A into respective airflows AF and deliver the airflows AF to chamber B. Further, the channels 103 direct the airflows AF toward a filter 104 of the impaction plate 105. The filter 104 allows certain particles of the respective airflows AF to pass by as shown in FIG. 2 while inertially directing larger size particles to the filter. The filter 104 can be made of Teflon and be a maximum of 25 mm diameter in this exemplary example. However, other diameters and materials that are known in the art can be used.

The present inventors have discovered that providing the impaction plate 105 with the filter 104 instead of a solid surface permits easy analysis of the particle weight collected and identification of the particle types by numerous methods known in the art.

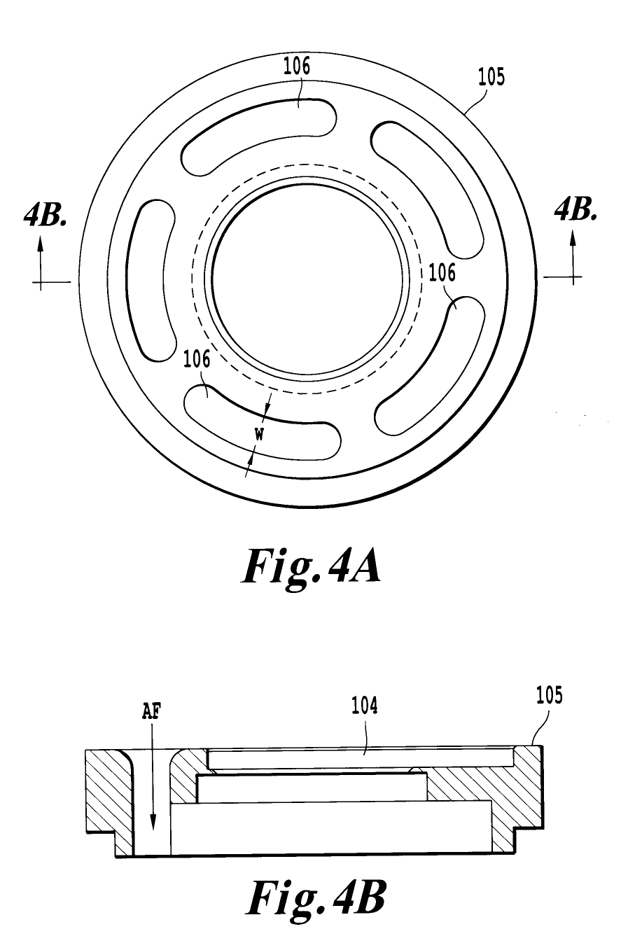

The impaction plate 105, which holds the filter 104, is made of Al in one exemplary embodiment. However, other materials know to the artisan can be used. The impaction plate 105 is shown in more detail in FIGS. 4A-B.

The airflow AF redirects smaller aerosol particles (below the cut-off point, for example 2.55 μm) away from the filter 104 toward one of a plurality of outlets 106, along a path E. FIG. 2 shows only one outlet 106 and one airflow AF for illustrative purposes. However, a plurality of outlets 106 are formed in the impaction plate 105 as shown in FIG. 4A. The airflow AF does not redirect the larger aerosol particles (above the cut-off point) from the filter 104 because these larger particles of the aerosols cannot change the momentum as quick as the small particles. Thus, the larger particles travel toward the filter 104. As a result, those larger particles are trapped on the filter 104 by impaction. Accordingly, the trapped particles having a diameter in a predetermined range, can be removed together with the filter 104 and analyzed.

Thus, in this second stage that includes for example the second chamber B, the filter 104, and the outlets 106, the small particles are separated from the airflow and allowed to advance to the third chamber C and the larger particles are deposited on the filter 104. Moreover, the second stage, by having both holes (outlets 106) and a filter (filter 104) at the same plane level, is able to better separate the particles while occupying a smaller volume than the device discussed above in the background art section. The large outlets 106 minimize particle deposition (loss) to surfaces besides the filters (filter 104 and filter 108) during transport from chamber B to chamber C. Large outlets 106 also minimize amount of metal comprising 105 and minimize total weight of the sampler.

The first stage of the apparatus, which can include for example the focus jet plate 102, separates the particles smaller than 10 μm by impacting the particles larger than 10 μm on the focus jet plate 102 and allows the smaller particles to advance to the second chamber B. Then, in the second stage, as discussed above, the particles larger than 2.5 μm are stopped and stored on the filter 104 while the smaller particles are allowed to advance to the third chamber C through the outlets 106. The filter 104 may have a diameter of 25 mm. Other larger and smaller diameters can be used.

The particles of the airflow AF then advance through a filter 108 which further separates particles larger than a predetermined diameter from smaller particles. Filters 104 and 108 can be Teflon, other polymer membrane, paper, or glass fiber type filter. The filter 108 may have a diameter of 37 mm and may be made of Teflon. The filter 108 can store particles having a diameter of less than 2.5+/−0.05 μm. However, other sizes and materials can be used for the filter 108. Finally, the particles remaining in the airflow AF advance to the fourth chamber D and are evacuated from the device through an outlet 110. The outlet 110 is connected to a pump to force the absorption of particles at the inlet 101 and the speed of the pump is set for example at 2 lpm (liters per minute) to take advantage of the existing pumps. However, pumps using a higher speed can be used with the device of the present embodiment.

It is noted that the apparatus of the embodiment shown in FIG. 2 collects fine and coarse PM (particle mass) concentrations. Analysis of these PM increases the understanding of sources and personal exposure to PM. Such analysis shows that particles having a diameter in the range of 2 to 10 μm become easily entrapped on the human bronchial tubes and lungs and thus, the apparatus of this embodiment is desirably for collecting the particles in the 2 to 10 μm range with a high accuracy. The high accuracy of particles having a diameter in the 2 to 10 μm range stored in the second stage of the apparatus of this embodiment is achieved by using the filter 104 in conjunction with the plate 105 having the outlets 106 shaped as will be described later with reference to FIGS. 4A-B.

The channels 103 in one embodiment of the invention are cylindrical holes focusing the aerosol in a direction orthogonal to the impaction plate 105. However, the focus jets 103 may be rearranged, tapered, reduced in depth or diameter, or otherwise manipulated to create an airflow AF velocity, origin, direction, and shape appropriate for the intended cut-off point. The number of nozzles can be altered. The shape can also be altered and can be any quadrilateral as well as circular. For instance, the channels 103 may be angled, with respect to the normal to the filter 104, toward their respective outlets 106. Similarly, the filter 104 may be angled, e.g., have a concave shape, to better collect large particles when designed to do so. Furthermore, the channels 103 can have a radial width and tapered edges with an outside of the tapered edges extending beyond the radial width by 5%, 10%, or 20%.

One exemplary embodiment of the invention employs five outlets 106, but fewer or more outlets 106 may be employed. This embodiment also employs an equal number of channels 103 and outlets 106, arranges the filter 104 and outlets 106 in similar configurations, and arranges the channels 103 and outlets 106 in a radially symmetrical configuration. As with the channels 103, different arrangements, shapes, depths, etc., may be employed.

The configuration of this embodiment shown in FIGS. 3A-B may reduce a cross-flow in one or more respects. First, because an equal number of channels 103 and outlets 106 are employed, each airflow AF may be allocated a separate and sufficiently large outlet 106. More particularly, the airflows AF may be better separated from another, thereby lessening their opportunities to impact one another. Further, each airflow AF may be allocated a sufficiently large outlet 106, thereby reducing a resistance at a respective outlet 106.

Second, the one-to-one correspondence between each channel 103 and outlet 106 may also reduce the potential number of encumbrances upon each airflow AF. For instance, in this embodiment, each airflow AF encounters only one outlet 106 before exiting the second chamber. If a respective airflow passes two or more outlets, that airflow could be disrupted by the extra outlet. Further, that airflow may have less opportunity to contact an impaction plate before reaching an outlet.

Third, because of the relationship between the channels 103 and outlets 106, each airflow AF is similarly situated with respect to another. Consequently, the impact of any two airflows AF upon one another may be mutually offsetting. Further, the competing effects of the airflows AF may be more predictable. A radial symmetry of the channels 103 and outlets 106 is a particular example of the relationship between the channels 103 and outlets 106.

Another embodiment of the invention employs oversized outlets 106. The oversized outlets 106 reduce the weight of the impaction plate 105. Further, if the outlets 106 are stretched along the perimeter of the impaction plate 105, then each airflow AF may be provided a wider path to a respective one or more outlets 106. By traversing a greater filter 104, a wider airflow AF path may disperse the trapped particles over a greater surface area; and may provide more opportunity for an aerosol particle to contact a clean portion of the filter 104. Since the filtered aerosol particles are less likely to contact another trapped particle, they may be more effectively trapped by the clean (no aerosol particles trapped) filter 104.

After passing the outlets 106, the remaining particles can be filtered by filter 108 to further remove particles in a desired range. For example, if the filter 104 has trapped by impaction the particles from AF having a diameter of 2.5 μm or larger, the filter 108 can be used to trap the particles in the AF having a diameter less than 2.5 μm.

With regard to FIG. 3A, the focus jet plate 102 is shown having five channels 103 and FIG. 3B shows a cross section along line BB′ in FIG. 3A of the focus jet plate showing only one channel 103. It is noted that the circumferential portion 102a of the focus jet plate 102 is the portion where the large particles traveling from outside the particle sampler to chamber B through chamber A are impacted and stopped. In the context of the example discussed above, the particles having a diameter larger than 10 μm would be collected in region 102a, where the oily layer 111 for example may be provided, and the smaller particles travel to chamber B though the channels 103.

With regard to FIG. 4A, the impaction plate 105 is shown having an opening where the filter 104 is to be positioned and slits (outlets) 106 that communicate the chamber B with chamber C. The filter 104 can be made of the same material as the impaction plate 105 and can be integrally made with the impaction plate 105. In one embodiment, the filter 104 is made of a different material from the impaction plate 105 and is removably attached with a ring 104a to the impaction plate 105.

Optionally, a seal is provided between the plate 105 and the filter 104 to prevent aerosols from traveling from chamber B to chamber C outside outlets 106. The outlets 106 have a length larger than a width and are disposed to a periphery of the impaction plate 105, such that the slits 106 are not directly under the channels 103. FIG. 4B shows the impaction plate in a cross-sectional view.

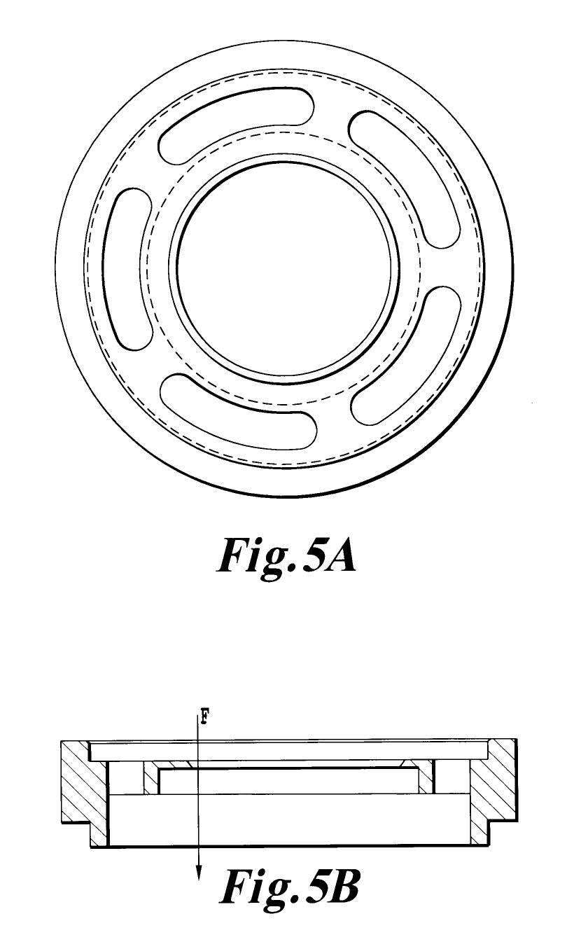

In another non-limiting embodiment of the invention, a collection force F may be applied toward the filter 104 as shown in FIGS. 5A-B. For instance, the collection force F may be applied such that the trapped particles above the cut-off point are more firmly secured to the filter 104 but without altering the cut-off point by drawing particles from the airflow AF to the filter 104. The collection force holding the particles following impaction naturally occurs. This force is an adhesion force. For example, naturally occurring electrostatically induced forces occur between the filter 104 and the collected particle is the main adhesion force. In one embodiment, the collection force F is provided orthogonal to the filter 104. The collection force F is insufficient to draw the aerosol particles away from the airflow AF. Thus, the collection force F does not significantly impact the cut-off point or filter performance. The force F may be administered by gravity, electrostatic attraction, Van der Waals forces, etc. Adhesion may also be increased by employing a gel or other adherent compound on the surface of the filter 104 that faces the jet focus plate 102.

The coarse particle sampler discussed in the above embodiments, which collects aerosol medium on a filter, is suited for personal environment monitoring. In fact, the particle sampler may be worn by an individual in the field to collect and store the aerosols to which the individual is exposed to in the environment. The particle sampler is also suitable for stationary sample collection inside buildings or outside in ambient environment.

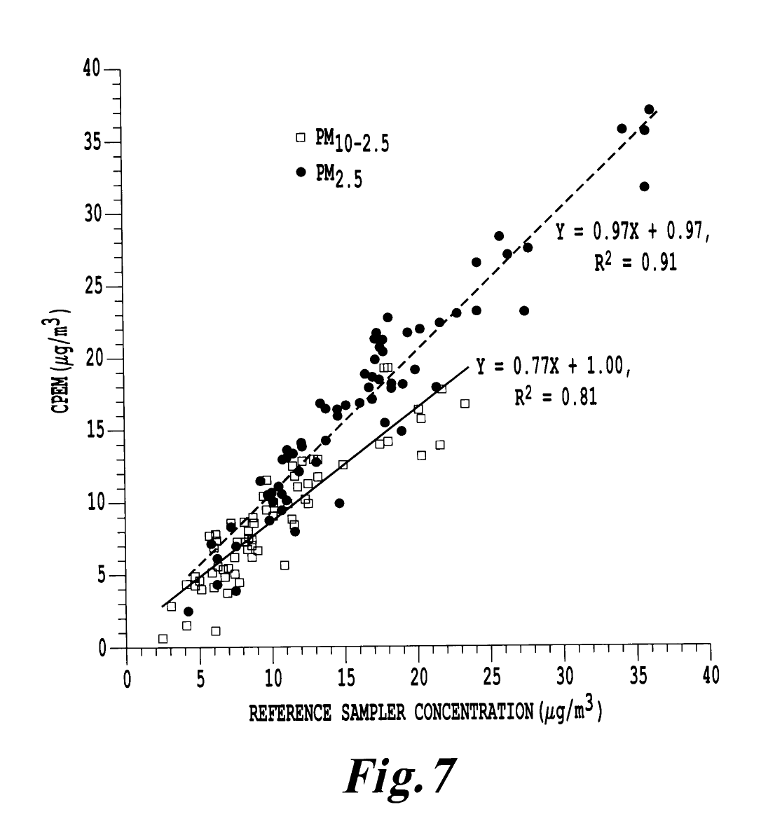

Thus, the particle sampler discussed in the above embodiments can separate the particles in an aerosol in coarse and fine mass concentrations as desired. The desired ranges can be selected in the disclosed particle sampler more narrowly than in the background art devices. Tests performed by the inventors regarding the capabilities of the disclosed particle sampler were performed and compared against multiple metrics. A direct comparison of the coarse and fine fraction mass concentrations of the present particle sampler was performed with the corresponding mass concentrations of reference sampler, an Andersen Model SA-244 Dichotomous sampler (Andersen, Smyrna, Ga.) (FIG. 7).

Thus, the invention encompasses a number of counter intuitive design aspects.

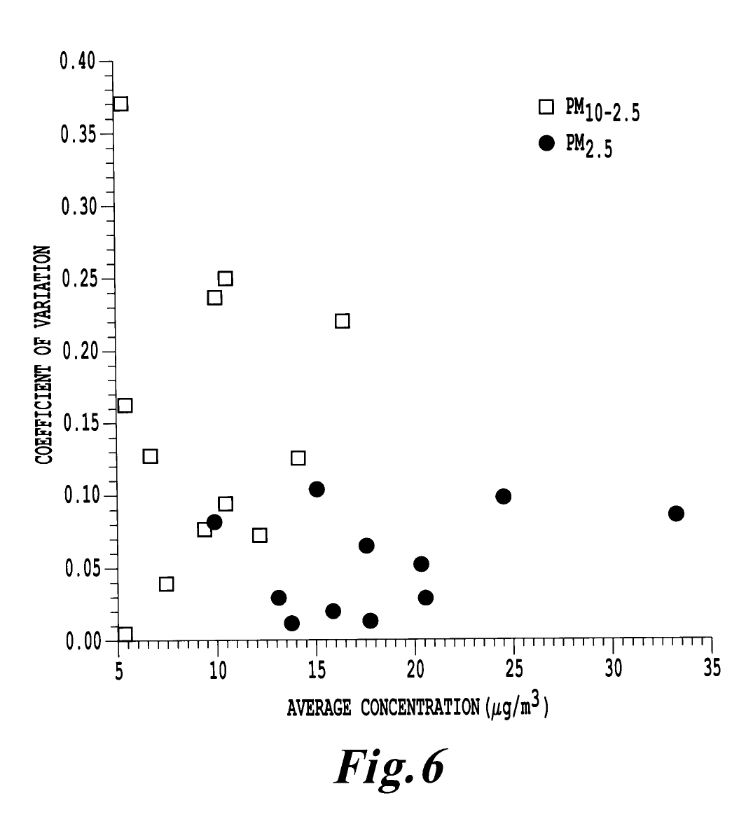

The entire sampler shown in element 100 has small dimensions, low weight and operates at a low airflow, as opposed to prior devices, making it suitable to be worn by a person. The precision of sampler is acceptable, coefficient of variance less than 0.25, for a low airflow instrument (FIG. 6). The accuracy of the sampler is as good as prior art (FIG. 7).

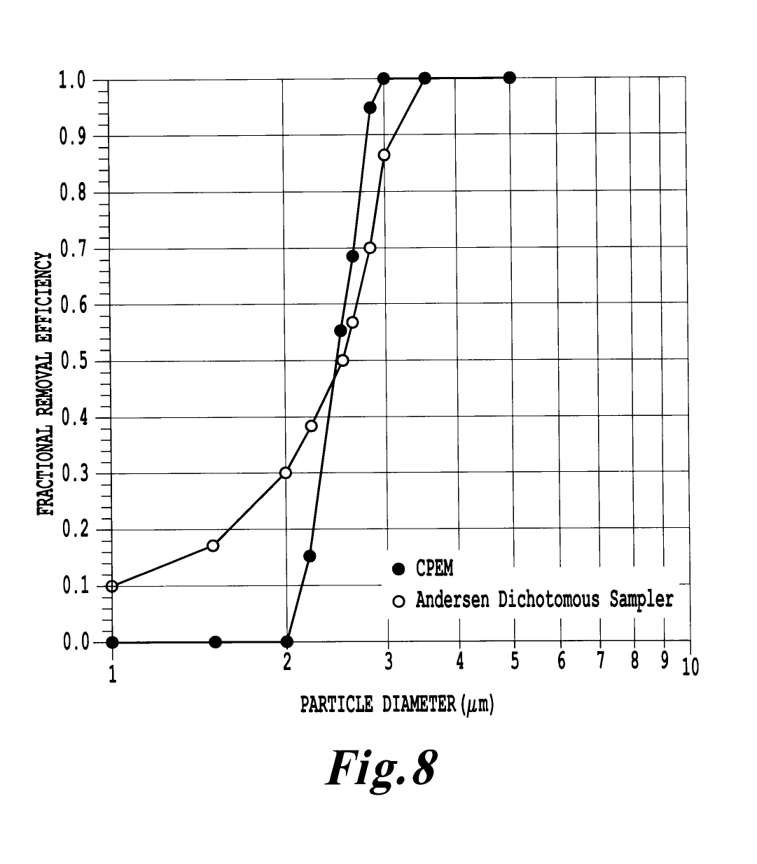

The number of orifices and orifice dimensions for elements 103 shown in FIG. 3A are the result of technically determining a tradeoff between 1) maintaining an airflow with a sufficient velocity to inertially direct the coarse particles out of the air stream for collection on filter element 104 (which would require smaller restrictions on each orifice and limited number of restrictions) 2) while maintaining a sufficient flow through the filter apparatus to permit particle collection 3) minimizing particle deposition onto the orifice walls 4) collection of particles over the smallest area on filter element 104 and 5) each orifice is configured to receive an equal airflow including aerosols to be captured by the filter. This effect results in a superior separation efficiency compared to an Andersen Dichotomous Sampler reference instrument (FIG. 8).

The flow diversion channels (items 106 in FIG. 4B) are placed at enough radial displacement from the orifices 103 and of sufficient dimensions that 1) fine particles remain in the air stream and are directed to filter element 108 2) laminar flow is maintained continuously 3) particle deposition to sampler walls is minimized and 4) fine particles are uniformly collected on filter element 108.

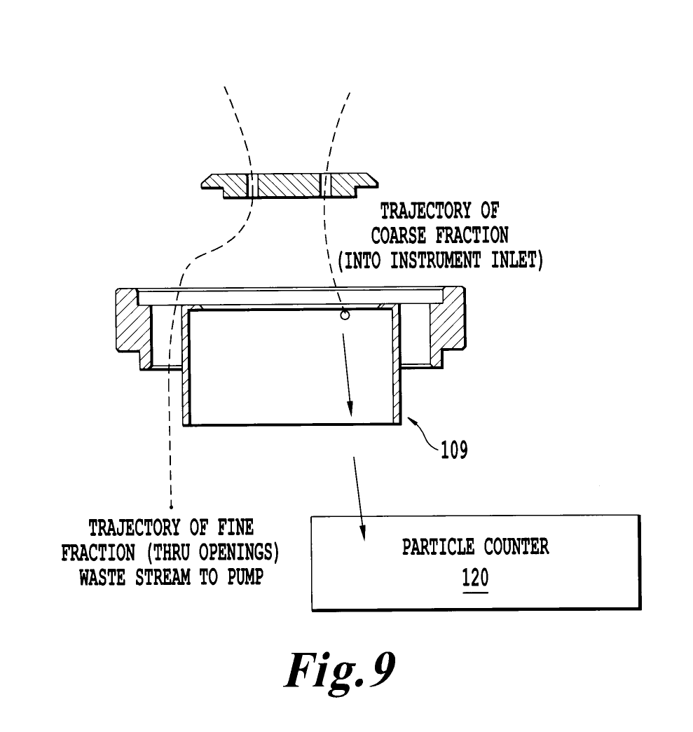

FIG. 9 illustrates an alternative configuration of the invention which permits coarse particles to be carried into a particle counter 120 rather than to be trapped in a filtration medium, as detailed above. This configuration is possible by removal of filter 104 and inclusion of a hollow cylinder (element 109) that can extend to the inlet of the particle counter. Otherwise, the remaining components function as described above. For example, both inertia and gravity forces can carry the coarse particles to the particle counter 120. Particles still pass through the flow orifices (elements 103) to provide the acceleration for inertial separation. Fine particles still follow the airflow through the flow diversion channels (element 106).

In this embodiment, the focus jet plate 102 can use the configurations described above and employing the different channel 103 configurations described above. FIG. 9 shows for sake of simplicity separately the direction of the lighter mass or finer particles away from particle counter 120 and the direction of the higher mass or coarser particles into particle counter 120. The invention can utilize known particle counters and particle counting methods to collect particles from the focus jet plate 102. For example, suitable particle counters suitable for the invention include those described in U.S. Pat. No. 5,561,515 and U.S. Pat. No. 6,016,194 and U.S. Pat. No. 6,055,052, the entire contents of which are incorporated herein by reference.

Numerous modifications and variations of the invention are possible in light of the above teachings. It is therefore to be understood that within the scope of the appended claims, the invention may be practiced otherwise than as specifically described herein.

1. A filter apparatus, comprising:
a housing having at least one opening by which a fluid is introduced thereto;
a first plate inside the housing and having a plurality of inlets offset from a central axis of the housing and angularly separated from each other, said inlets configured to pass said fluid thereto;
a second plate inside the housing, disposed downstream from the first plate, and having angularly extending outlets disposed at a radial distance from said central axis which is beyond said plurality of inlets such that said fluid is diverted radially outward in passing from the first plate through the second plate;
a first filter provided on the second plate underneath the plurality of inlets and configured to trap particles in the fluid which are not diverted to the angularly extending outlets; and
an exit disposed downstream from the first plate by which said fluid exits the housing.

2. The filter apparatus of claim 1, wherein the inlets is symmetrically distributed around the first plate.

3. The filter apparatus of claim 1, wherein the plurality of inlets comprises inlets having nominally the same size openings.

4. The filter apparatus of claim 3, wherein the angularly extending outlets comprises outlets having nominally the same size openings.

5. The filter apparatus of claim 1, wherein the inlets comprises 2 to 5 inlets or 1 to 10 inlets.

6. The filter apparatus of claim 5, wherein the angularly extending outlets comprises 2 to 5 outlets or 1 to 10 outlets.

7. The filter apparatus of claim 1, wherein the angularly extending outlets have tapered edges on a side of the second plate facing the first plate.

8. The filter apparatus of claim 7, wherein the angularly extending outlets have a radial width and an outside of the tapered edges extends beyond said radial width by 5%.

9. The filter apparatus of claim 7, wherein the angularly extending outlets have a radial width and an outside of the tapered edges extends beyond said radial width by 10%.

10. The filter apparatus of claim 7, wherein the angularly extending outlets have a radial width and an outside of the tapered edges extends beyond said radial width by 20%.

11. The filter apparatus of claim 1, wherein the angularly extending outlets are positioned at an angular position to be aligned angularly with centers of the plurality of inlets.

12. The filter apparatus of claim 11, wherein the plurality of inlets is symmetrically disposed on the first plate.

13. The filter apparatus of claim 1, wherein the angularly extending outlets are arranged angularly with equal intervals separating adjacent ones of the angularly extending outlets.

14. The filter apparatus of claim 1, wherein the first filter comprises at least one of a natural or synthetic material.

15. The filter apparatus of claim 1, further comprising:
a second filter disposed downstream from the second plate and in front of the exit.

16. The filter apparatus of claim 15, wherein the second filter comprises at least one of a natural or synthetic material.

17. The filter apparatus of claim 1, wherein the plurality of inlets and the angularly extending outlets are disposed such that said fluid diverts radially outward and entrains particles having a size less than a target diameter, and particles greater than said target diameter are trapped in the first filter.

18. The filter apparatus of claim 1, further comprising:
a second filter disposed downstream from the second plate and in front of the exit, wherein particles less than said target diameter are trapped in the second filter.

19. A coarse portable exposure monitor for personal environment monitoring, comprising:
a housing having at least one opening by which a fluid is introduced thereto;
a first plate inside the housing and having a plurality of inlets offset from a central axis of the housing and angularly separated from each other, said inlets configured to pass said fluid thereto;
a second plate inside the housing, disposed downstream from the first plate, and having angularly extending outlets disposed at a radial distance from said central axis which is beyond said plurality of inlets such that said fluid is diverted radially outward in passing from the first plate through the second plate;
a first filter provided on the second plate underneath the plurality of inlets and configured to trap particles in the fluid which are not diverted to the angularly extending outlets; and
an exit disposed downstream from the first plate by which said fluid exits the housing.
a pump connected to the exit and configured to draw said fluid into the at least one opening and through the first and second plates to the exit.

20. The monitor of claim 19, wherein the plurality of inlets is symmetrically distributed around the first plate.

21. The monitor of claim 19, wherein the plurality of inlets comprises inlets having nominally the same size openings.

22. The monitor of claim 21, wherein the angularly extending outlets comprises outlets having nominally the same size openings.

23. The monitor of claim 19, wherein the plurality of inlets comprises 2 to 5 inlets or 1 to 10 inlets.

24. The monitor of claim 23, wherein the angularly extending outlets comprises 2 to 5 outlets or 1 to 10 outlets.

25. The monitor of claim 19, wherein the angularly extending outlets have tapered edges on a side of the second plate facing the first plate.

26. The monitor of claim 25, wherein the angularly extending outlets have a radial width and an outside of the tapered edges extends beyond said radial width by 5%.

27. The monitor of claim 25, wherein the angularly extending outlets have a radial width and an outside of the tapered edges extends beyond said radial width by 10%.

28. The monitor of claim 25, wherein the angularly extending outlets have a radial width and an outside of the tapered edges extends beyond said radial width by 20%.

29. The monitor of claim 19, wherein the angularly extending outlets are positioned at an angular position to be aligned angularly with centers of the plurality of inlets.

30. The monitor of claim 29, wherein the plurality of inlets is symmetrically disposed on the first plate.

31. The monitor of claim 19, wherein the angularly extending outlets are arranged angularly with equal intervals separating adjacent ones of the angularly extending outlets.

32. The monitor of claim 19, wherein the first filter comprises at least one of a natural or synthetic material.

33. The monitor of claim 19, further comprising:
a second filter disposed downstream from the second plate and in front of the exit.

34. The monitor of claim 33, wherein the second filter comprises at least one of a natural or synthetic material.

35. The monitor of claim 19, wherein the plurality of inlets and the angularly extending outlets are disposed such that said fluid diverts radially outward and entrains particles having a size less than a target diameter, and particles greater than said target diameter are trapped in the first filter.

36. The monitor of claim 19, further comprising:
a second filter disposed downstream from the second plate and in front of the exit, wherein particles less than said target diameter are trapped in the second filter.

37. A system for particle detection, comprising:
a housing having at least one opening by which a fluid is introduced thereto;
a first plate inside the housing and having a plurality of inlets offset from a central axis of the housing and angularly separated from each other, said inlets configured to pass said fluid thereto;
a second plate inside the housing, disposed downstream from the first plate, and having angularly extending outlets disposed at a radial distance from said central axis which is beyond said plurality of inlets such that said fluid is diverted radially outward in passing from the first plate through the second plate;
a particle counter interface to the second plate underneath the plurality of inlets and configured to collect particles in the fluid which are not diverted to the angularly extending outlets; and
an exit disposed downstream from the first plate by which said fluid exits the housing.

38. The system of claim 37, wherein the inlets is symmetrically distributed around the first plate.

39. The system of claim 37, wherein the plurality of inlets comprises inlets having nominally the same size openings.

40. The system of claim 39, wherein the angularly extending outlets comprises outlets having nominally the same size openings.

41. The system of claim 37, wherein the inlets comprises 2 to 5 inlets or 1 to 10 inlets.

42. The system of claim 41, wherein the angularly extending outlets comprises 2 to 5 outlets or 1 to 10 outlets.

43. The system of claim 37, wherein the angularly extending outlets have tapered edges on a side of the second plate facing the first plate.

44. The system of claim 43, wherein the angularly extending outlets have a radial width and an outside of the tapered edges extends beyond said radial width by 5%.

45. The system of claim 43, wherein the angularly extending outlets have a radial width and an outside of the tapered edges extends beyond said radial width by 10%.

46. The system of claim 45, wherein the angularly extending outlets have a radial width and an outside of the tapered edges extends beyond said radial width by 20%.

47. The system of claim 37, wherein the angularly extending outlets are positioned at an angular position to be aligned angularly with centers of the plurality of inlets.

48. The system of claim 47, wherein the plurality of inlets is symmetrically disposed on the first plate.

49. The system of claim 37, wherein the angularly extending outlets are arranged angularly with equal intervals separating adjacent ones of the angularly extending outlets.
